(19) United States
(12) Patent Application Publication
(10) Pub. No.: US 2006/0091748 A1
(43) Pub. Date: May 4, 2006

(54) Driving apparatus

(75) Inventors: Kazue Yoda, Nagano-ken (JP); Tetsuo Miyasaka, Nagano-ken (JP)

Correspondence Address: BACON & THOMAS, PLLC, 625 SLATERS LANE, FOURTH FLOOR, ALEXANDRIA, VA, 22314, US

(73) Assignee: Maruyasu Kikai Co., Ltd., Nagano-ken (JP)

(21) Appl. No.: 11/244,235

(22) Filed: Oct. 6, 2005

(30) Foreign Application Priority Data
Nov. 1, 2004 (JP) 2004-317976

(51) Int. Cl. H02K 7/10

(52) U.S. Cl. 310/83

(57) ABSTRACT

The present invention provides a driving apparatus utilizing magnetic force, which is capable of establishing an enhanced level of higher torque, without enlarging the diameters of the drive magnetic wheel and the follower magnetic wheel, or without installing another transmission system branching off the drive shaft. The driving apparatus where the drive shaft and the follower shaft are arranged in such a manner as crossing each other at right angles, and a non-contact type power transmission mechanism utilizing magnetic force performs power transmission from the drive shaft to the follower shaft, wherein, magnetic wheels are installed respectively on the drive shaft and the follower shaft, each of the magnetic wheels being formed by spirally magnetized into N-pole and S-pole alternately, and plural points are coaxially provided which produce magnetic actions from one magnetic wheel to another magnetic wheel.

### BACKGROUND OF THE INVENTION

1. Field of the Invention

The present invention relates to a driving apparatus which utilizes a magnetic wheel so as to transmit rotational driving force without any contact action.

2. Description of the Related Art

Generally, a transmission driving device using gears is employed as a means for transmitting a rotational force in a machine tool, industrial machine, and the like. However, since this conventional transmission driving device using gears transmits the rotational force by allowing the gears to be engaged with one another, there is a possibility of tooth plane abrasion, dust generation, and noise occurrence, and further, a high torque or impact may cause a risk of damage.

Considering the above situation, in order to solve the problems of the conventional driving device using gears as described above, there is proposed a driving apparatus utilizing a magnetic wheel which transmits a rotational force in a non-contact state.

The driving apparatus utilizing the magnetic wheel is provided with a drive magnetic wheel spirally magnetized into N-pole and S-pole alternately and a follower magnetic wheel which is magnetized into N-pole and S-pole alternately along the circumferential direction, and the axes of the wheels crossing each other at right angles in a non-contact state (see Japanese Patent Application Laid-open Publication No. Hei 07-177724 (1995-177724), hereinafter referred to as “Patent Reference 1”).

However, in the driving apparatus as disclosed in the Patent Reference 1, the drive magnetic wheel and the follower magnetic wheel cross each other in a one-to-one relation, and power is transmitted from only one crossing point. Therefore, transmission torque towards a shaft (for example, roller shaft) is limited and low, on which the follower magnetic wheel being ultimately rotated is installed. Therefore, this kind of driving apparatus has been used for conveying relatively lightweight items or the like, and it has been inadequate to heavy load conveyance.

As a way to achieve a higher torque or enhanced torque, it is possible to consider enlarging the outer diameter of both the drive magnetic wheel and the follower magnetic wheel. However, if the diameters of the drive magnetic wheel and the follower magnetic wheel are made larger, it is a matter of course that cost is increased, and the entire driving apparatus grows in size. Consequently, it causes a problem that a system which utilizes this driving apparatus also grows in size.

As a technique to solve the problems above, the applicant who is filing the present application has already proposed a driving apparatus to transmit power to a follower magnetic wheel via plural transmission systems, from a drive magnetic wheel that is installed on a drive shaft (Japanese Patent Application No. 2004-84673).

In the invention of the already filed application, however, intermediate (idle) magnetic wheels serving as mediators are independently provided in the vicinity of the drive magnetic wheel and the follower magnetic wheel, and those intermediate wheels are required to be adjusted so that the magnetic poles are in phase.

### SUMMARY OF THE INVENTION

The present invention has been made in view of the problems in the conventional technique as described above, and the object of the present invention is to provide a driving apparatus utilizing magnetic force, which is capable of establishing a high torque, i.e., enhanced torque, coaxially with the axes of the drive magnetic wheel and the follower magnetic wheel, without enlarging the diameters of both wheels, or without installing an independent transmission system branching off the driving shaft.

In order to achieve the above object, technical means of the present invention is directed to a driving apparatus where a drive shaft and a follower shaft are arranged in such a manner as crossing each other at right angles, the drive shaft being driven to rotate appropriately by driving means, and a non-contact type power transmission mechanism utilizing magnetic force performs power transmission from the drive shaft to the follower shaft, wherein magnetic wheels are installed respectively on the drive shaft and the follower shaft, each of the magnetic wheels being formed by spirally magnetized into N-pole and S-pole alternately, and plural points are coaxially provided which produce magnetic actions from one magnetic wheel to another magnetic wheel. As the driving means which drives the drive shaft to rotate, any of the following means is applicable, that is, a method for transmitting rotation of a motor to the driving shaft via a currently known power transmission mechanism being a contact type, such as a belt transmission mechanism and a gear transmission mechanism, or a non-contact type power transmission mechanism utilizing magnetic force.

According to the above means, since there are provided coaxially plural points on which the magnetic actions are produced from the drive magnetic wheel installed on the drive shaft to the follower magnetic wheel installed on the follower shaft, whereby it is possible to enhance the level of synchronism loss limitation and achieve a higher transmission torque than a convention device which has magnetic action at only one place.

As a configuration to provide such plural points coaxially as described above, each producing a magnetic action, there is an example that the magnetic wheel on the drive shaft is formed in an hourglass shape, and the other magnetic wheel on the follower shaft is formed in a cylindrical shape to be suitable being inserted in the concave curve of the hourglass shaped magnetic wheel. Here, both of the magnetic wheels are arranged in such a manner as approaching each other in a non-contact state. It may also be configured such that the shaft on which the hourglass shaped magnetic wheel is defined as follower side, and the shaft on which the cylindrical shaped magnetic wheel is defined as drive side.

In addition, a specific configuration of the above hourglass shaped magnetic wheel may be the following: one cylindrical magnetic wheel and truncated conical shaped magnetic wheels on both sides of the cylindrical wheel are provided, in such a manner that the truncated surfaces of the conical magnetic wheels are arranged to be opposed to each other. It is also possible to configure such that the cylindrical shaped magnetic wheel and the truncated conical shaped magnetic wheels are formed respectively with curved outer surfaces in a shape of concave, thereby establishing a concave curved outline as a whole, so as to be along the outer surface of the cylindrical shaped magnetic wheel on the follower shaft side.

According to the means as described above, since the concave curve of the hourglass shaped magnetic wheel is opposed to the outer surface of the cylindrical shaped magnetic wheel arranged orthogonal thereto in a non-contact state, a portion for producing the magnetic action between both magnetic wheels is rendered to be linear mode along the axis of the hourglass shaped magnetic wheel. With this configuration, it is possible to establish a higher torque coaxially on the drive magnetic wheel shaft or the follower magnetic wheel shaft.

In addition, one cylindrical magnetic wheel and truncated conical shaped magnetic wheels on both sides are provided, in such a manner that the truncated surfaces of the conical magnetic wheels are arranged to be opposed to each other, whereby a magnetic wheel closely analogous to an hourglass shape can be easily formed. Furthermore, on the three points respectively at three places along the cylindrical shaped magnetic wheel and truncated conical shaped magnetic wheels on both sides coaxially provided, magnetic actions are performed with the other cylindrical shaped magnetic wheel arranged being orthogonal to the hourglass shaped wheel, thereby establishing an enhanced torque.

Another configuration to provide coaxial plural points for magnetic actions may be that the magnetic wheel on the drive shaft and the magnetic wheel on the follower shaft are respectively formed in an hourglass shape, and concave curves of both magnetic wheels are arranged in such a manner as crossing each other at right angles in a non-contact state.

A specific configuration to form the above hourglass shaped magnetic wheels is as the following: one cylindrical magnetic wheel and truncated conical shaped magnetic wheels on both sides are provided, in such a manner that the truncated surfaces of the conical magnetic wheels are arranged to be opposed to each other, and the hourglass shaped magnetic wheels on both shafts are arranged in such a manner as crossing each other at right angles in a non-contact state.

According to the means as described above, since the concave curves of the hourglass shaped magnetic wheels respectively installed on the drive shaft and the follower shaft cross each other at right angles in a non-contact state, a portion for producing the magnetic action between both magnetic wheels is rendered to be linear mode along the axis of the hourglass shaped magnetic wheel. With this configuration, it is possible to establish an enhanced torque coaxially with the drive magnetic wheel shaft or the follower magnetic wheel shaft.

In addition, if the hourglass shaped magnetic wheel includes one cylindrical magnetic wheel and truncated conical shaped magnetic wheels on both sides, in such a manner that the truncated surfaces of the conical magnetic wheels are arranged to be opposed to each other, on the three points respectively at three places along the cylindrical shaped magnetic wheel and truncated conical shaped magnetic wheels on both sides coaxially provided, the magnetic actions are performed with the other cylindrical shaped magnetic wheel arranged being orthogonal to the hourglass shaped wheel, thereby establishing an enhanced torque.

Moreover, as for the hourglass shaped magnetic wheels on the drive shaft side and on the follower shaft side, it is possible to configure such that the truncated surfaces of the conical shaped magnetic wheels are arranged in such a manner as being opposed to each other on the axis, and the hourglass shaped magnetic wheels on both shafts are arranged being crossing each other at right angles in a non-contact state. In other words, in this configuration, the cylindrical shaped magnetic wheel disposed between the truncated conical shaped magnetic wheels is removed.

According to the means as described above, the truncated conical shaped magnetic wheels installed on the drive shaft are arranged in such a manner as opposed to each other and those on the follower shaft are also arranged in such a manner as opposed to each other, and those are respectively on the axes crossing each other at right angles. Each of the truncated conical shaped magnetic wheels has one magnetic action point at one place with respect to each of the two magnetic wheels placed on both sides thereof. Therefore, there are four magnetic action points respectively on four places with respect to each shaft, thereby achieving a higher torque and allowing the distance between the axle centers crossing at right angles to be relatively narrower.

The cylindrical shaped magnetic wheel as a constituent element of the hourglass shaped magnetic wheel is spirally magnetized into N-pole and S-pole alternately. As for the truncated conical shaped magnetic wheel, it is spirally magnetized into N-pole and S-pole alternately and also there is formed a non-magnetized region between N-pole and S-pole.

With the means as described above, since the non-magnetized region is formed in a partitioned area between the N-pole and S-pole alternately arranged in spiral manner on the truncated conical shaped magnetic wheel, it is possible to prevent a simultaneous occurrence of absorption and repelling with respect to the magnetic wheel as a counterpart. Accordingly, it is possible to prevent interference (force which cancels rotation) from arising on the magnetic wheel.

According to the driving apparatus according to the present invention, there are provided coaxially plural points for magnetic actions between the magnetic wheels in a non-contact state, respectively installed on two axes (drive shaft and follower shaft) crossing each other at right angles, thereby enhancing the level of synchronism loss limitation and achieving a higher transmission torque with a more simplified configuration than a conventional driving device which utilizes magnetic force.

In addition, an hourglass shaped magnetic wheel fixed on the drive shaft or the follower shaft is made by combining a cylindrical shaped magnetic wheel and truncated conical shaped magnetic wheels, or alternatively by combining truncated conical shaped magnetic wheels only, and thus a magnetic wheel approximating an hourglass shape can be easily configured.

Furthermore, since the magnetic wheels are respectively installed on two axes being orthogonal to each other to establish a higher torque, it is possible to build this driving apparatus in a driving mechanism of a conveying machine, following almost the same procedure as of the conventional driving mechanism.

Since the non-magnetized region is formed in a partitioned area between N-pole and S-pole alternately arranged in spiral manner on the truncated conical shaped magnetic wheel, it is possible to prevent a simultaneous occurrence of absorption and repelling with respect to the magnetic wheel as a counterpart. Accordingly, it is possible to prevent interference (force which cancels rotation) from arising on the magnetic wheel.

### BRIEF DESCRIPTION OF THE DRAWING

FIG. 1 shows a driving apparatus according to the first embodiment of the present invention. FIG. 1A is a front view, FIG. 1B is a side view where one of truncated conical shaped magnetic wheel on the drive shaft is removed, and FIG. 1C is a plan view;

FIG. 2 is a perspective view of the driving apparatus according to the first embodiment of the present invention;

FIG. 3 shows a development of magnetization of magnetic poles applied on the truncated conical shaped magnetic wheel;

FIG. 4 shows a driving apparatus according to the second embodiment of the present invention. FIG. 4A is a front view where one of truncated conical shaped magnetic wheels on the follower shaft is removed, FIG. 4B is a side view where one of truncated conical shaped magnetic wheels on the drive shaft is removed, and FIG. 4C is a plan view;

FIG. 5 is a perspective view of the driving apparatus according to the second embodiment of the present invention;

FIG. 6 shows a driving apparatus according to the third embodiment of the present invention. FIG. 6A is a front view where one of truncated conical shaped magnetic wheels on the follower shaft is removed, FIG. 6B is a side view where one of truncated conical shaped magnetic wheels on the drive shaft is removed, and FIG. 6C is a plan view;

FIG. 7 is a perspective view of the driving apparatus according to the third embodiment of the present invention; and

FIG. 8 is a front view showing a modification of the drive magnetic wheel according to the first embodiment.

### DESCRIPTION OF THE PREFERRED EMBODIMENTS

The present invention is directed to a driving apparatus where a drive shaft and a follower shaft are arranged in such a manner as crossing each other at right angles, the drive shaft being driven to rotate appropriately by driving means, and a non-contact type power transmission mechanism utilizing magnetic force performs power transmission from the drive shaft to the follower shaft, wherein a drive magnetic wheel and a follower magnetic wheel are installed respectively on the drive shaft and the follower shaft, each of the magnetic wheels being formed by spirally magnetized into N-pole and S-pole alternately and plural points which produce magnetic actions from one magnetic wheel to another magnetic wheel are provided coaxially with the shaft on which the drive magnetic wheel is installed. In other words, without placing another shaft to install the magnetic wheel, in addition to the drive shaft on which the drive magnetic wheel is installed and the follower shaft on which the follower magnetic wheel is installed, the magnetic wheels are configured such that plural magnetic action points are produced on the drive shaft or on the follower shaft.

Hereinafter, specific configuration examples of the present invention will be explained with reference to preferred embodiments.

### EXAMPLE 1

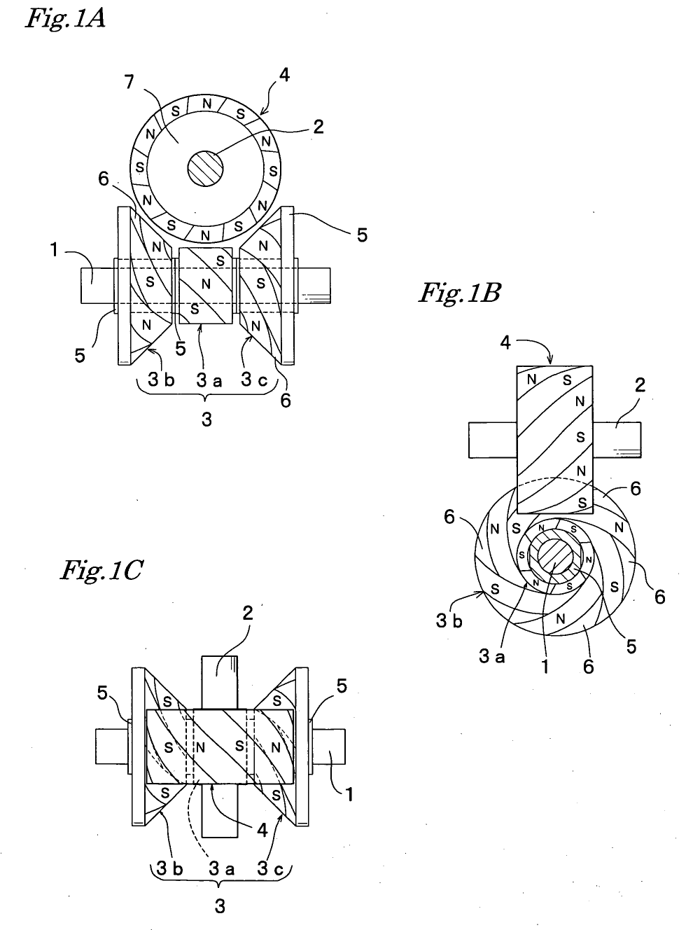

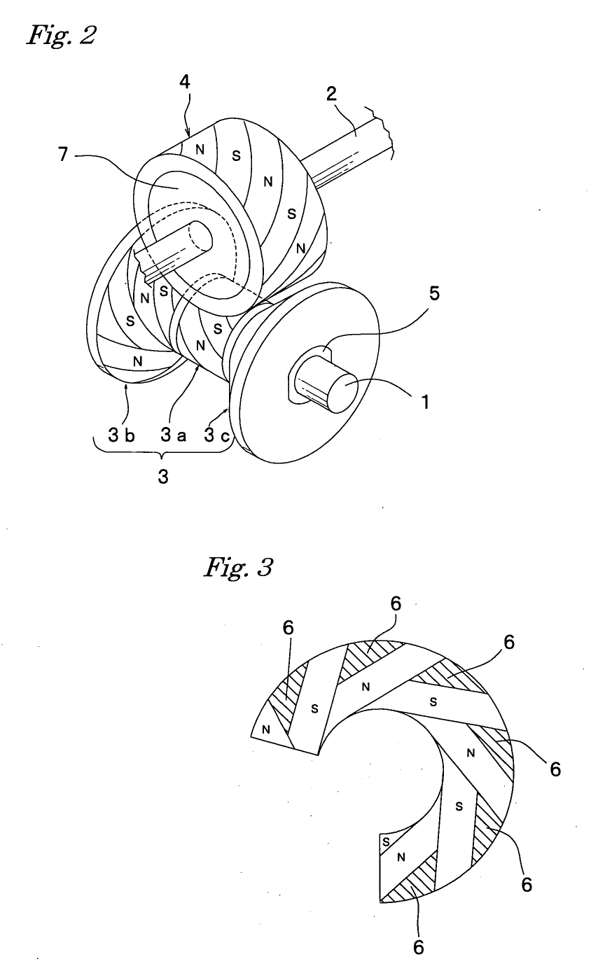

FIG. 1 and FIG. 2 show a driving apparatus in which a magnetic action is produced on three points respectively at three places on the drive magnetic wheel installed on the drive shaft with respect to the follower cylindrical shaped magnetic wheel installed on the follower shaft, both magnetic wheel being arranged in a non-contact state, and then power is transmitted. In those figures, reference numeral 1 indicates a drive shaft, numeral 2 indicates a follower shaft, both being arranged in such a manner as crossing each other at right angles, numeral 3 indicates a drive magnetic wheel fitted into the drive shaft 1 and fixed thereon, and numeral 4 indicates a follower magnetic wheel fitted into the follower shaft 2 and fixed thereon.

The drive magnetic wheel 3 fitted into the drive shaft 1 and fixed thereon includes a cylindrical shaped magnetic wheel 3a and truncated conical shaped magnetic wheels 3b and 3c placed on both sides in the axial direction of the cylindrical shaped magnetic wheel. Here, the truncated conical shaped magnetic wheels 3b and 3c are arranged in such a manner that the truncated surfaces are opposed to each other and the cylindrical shaped magnetic wheel 3a is placed therebetween.

The outer diameters of the truncated side of the magnetic wheels 3b and 3c placed on both sides of the magnetic wheel 3a are approximately the same as that of the outer diameter of the magnetic wheel 3a, whereby the outer surface of the cylindrical shaped magnetic wheel 3a and the truncated conical shaped magnetic wheels 3b and 3c configure almost hourglass shape.

The magnetic wheel 3a as a constituent element of the drive magnetic wheel 3 is made of permanent magnet in a short cylindrical shape and is formed by spirally magnetizing the outer surface thereof into N-pole and S-pole alternately. The magnetic poles and pitch on the magnetic wheel 3a is set to correspond to the magnetic poles and pitch on the follower magnetic wheel 4 which is placed in opposed manner.

Similar to the magnetic wheel 3a, the magnetic wheels 3b and 3c as constituent elements of the drive magnetic wheel 3 are made of permanent magnet in a truncated conical shape, and the truncated surface is spirally magnetized into N-pole and S-pole alternately, as shown in the magnetization development in FIG. 3.

Also as shown in FIG. 3, a non-magnetized region 6 is formed between the magnetized zone, which is magnetized into N-pole or S-pole spirally, thereby reducing magnetic influence (interference) in each phase. It is to be noted that FIG. 3 shows six-pole spiral magnetization (90° rightward spirals) as a magnetization mode on the truncated conical shaped magnetic wheels 3b and 3c.

The magnetic wheels 3a to 3c as configured above may be directly fitted into the drive shaft 1 and fixed thereon. Alternatively, they may be fitted into an installation ring 5 made of synthetic resin and attached thereto, and then, the installation ring 5 may be fitted into the drive shaft 1 and fixed thereon.

The follower magnetic wheel 4, which is arranged in such a manner as orthogonal to the drive magnetic wheel 3 in a non-contact state, is made of permanent magnet in a form of short cylindrical shape and the outer surface thereof is spirally magnetized into N-pole and S-pole alternately, similar to the magnetic wheel 3a being a constituent element of the drive magnetic wheel 3. The diameter of the follower magnetic wheel 4 is set to develop a minute space with the outer surfaces of the magnetic wheels 3a, 3b, and 3c constituting the drive magnetic wheel 3. It is to be noted that the magnetization mode of the cylindrical shaped follower magnetic wheel 4 as illustrated is a twelve-pole spiral magnetization.

The follower magnetic wheel 4 as configured above maybe directly fitted into the follower shaft 2 and fixed thereon. Alternatively, the follower magnetic wheel 4 may be fitted into an installation ring 7 made of synthetic resin and attached thereto, and then, the installation ring 7 may be fitted into the drive shaft 2 and fixed thereon. Here, a method for fixing the magnetic wheel may be any type of fixing method that has been conventionally employed. Furthermore, the installation rings 5 and 7 are not limited to the ones made of synthetic resin.

In the driving apparatus as configured above, the cylindrical magnetic wheel 3a, and truncated conical shaped magnetic wheels 3b, 3c disposed on both sides in the axial direction of the cylindrical magnetic wheel 3a, which are constituent elements of the drive magnetic wheel 3 fixed on the drive shaft 1, produces magnetic actions with the follower magnetic wheel 4 on the follower shaft 2 which is arranged in such manner as being orthogonal to the drive shaft. For example, as shown in the figure, the cylindrical shaped magnetic wheel 3a is located in opposed manner on the perpendicular line from the axle center of the follower magnetic wheel 4, and N-pole of the follower magnetic wheel 4 is facing S-pole of the magnetic wheel 3a, as well as N-poles on the magnetic wheels 3b, 3c are respectively facing S-poles on the follower magnetic wheel 4, thereby producing magnetic actions. Accordingly, power transmission from the drive magnetic wheel 3 to the follower magnetic wheel 4 is performed on three points respectively at three places on the drive shaft 1. As a result, it is possible to enhance the level of synchronism loss limitation and achieve a higher transmission torque, compared to the case where the power transmission is performed in a conventional driving apparatus where the magnetic action is produced on one point at one place.

### EXAMPLE 2

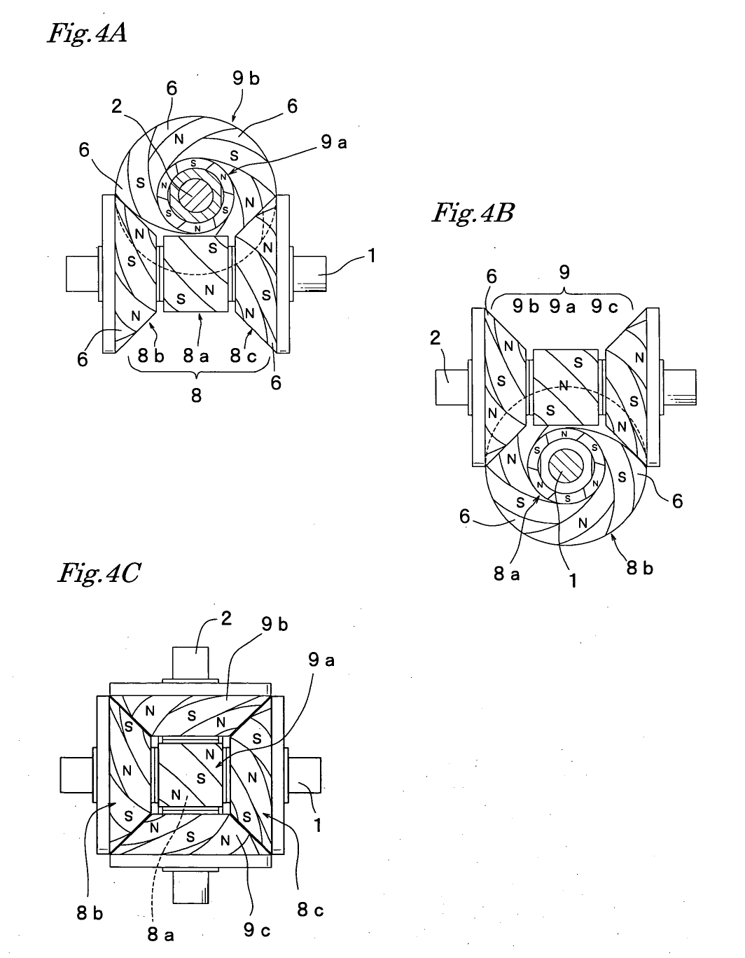

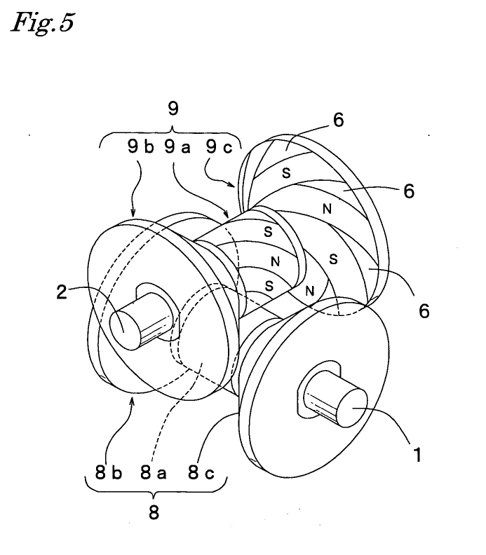

FIG. 4 and FIG. 5 show a driving apparatus having a drive magnetic wheel 8 fixed on the drive shaft 1 and a follower magnetic wheel 9 fixed on the follower shaft 2, both formed in an hourglass shape, and those magnetic wheels 8 and 9 are arranged in such a manner that concave curves thereof cross each other at right angles in a non-contact state.

Similarly to the follower magnetic wheel 4 as described in the Example 1 above, the hourglass shaped magnetic wheel 8 includes a cylindrical shaped magnetic wheel 8a, and truncated conical shaped magnetic wheels 8b, 8c on both sides in the axial direction of the magnetic wheel 8a, the truncated surfaces being arranged to be opposed to each other. In a similar manner, the hourglass shaped magnetic wheel 9 includes a cylindrical shaped magnetic wheel 9a, and truncated conical shaped magnetic wheels 9b, 9c on both sides in the axial direction of the magnetic wheel 9a, the truncated surfaces being arranged to be opposed to each other.

In other words, in Example 2, the follower magnetic wheel 4 as in the Example 1 is replaced with a structure similar to the drive magnetic wheel 3 as shown in Example 1, and those magnetic wheels are arranged to cross each other at right angles in a non-contact state. Here, the cylindrical shaped magnetic wheels 8a and 9a which constitute the driver magnetic wheel 8 and the follower magnetic wheel 9, and truncated conical shaped magnetic wheels 8b, 8c, 9b, and 9c are formed so that each has the same diameter.

In addition, the magnetization modes on the cylindrical shaped magnetic wheels 8a, 9a which constitute the driver magnetic wheel 8 and the follower magnetic wheel 9, truncated conical shaped magnetic wheels 8b, 8c, and 9b, 9c respectively constituting the drive magnetic wheel 8 and the follower magnetic wheel 9, are the same as those on the cylindrical shaped magnetic wheel 3a, truncated conical shaped magnetic wheels 3b, 3c, which constitute the drive magnetic wheel 3 in Example 1.

In the driving apparatus configured as described above, the cylindrical shaped magnetic wheel 8a that is a constituent element of the drive magnetic wheel 8 fixed on the drive shaft 1 produces a magnetic action with the cylindrical shaped magnetic wheel 9a that is a constituent element of the follower magnetic wheel 9 fixed on the follower shaft 2. In addition, the truncated conical shaped magnetic wheels 8b, 8c placed on both sides in the axial direction of the magnetic wheel 8a respectively produce magnetic actions with the truncated conical shaped magnetic wheels 9b, 9c placed on both sides in the axial direction of the cylindrical shaped magnetic wheel 9a. In other words, as for the truncated conical shaped magnetic wheels 8b and 8c of the drive magnetic wheel 8, two poles located nearly on the diameters respectively produce magnetic actions with the truncated conical shaped magnetic wheels 9b, 9c simultaneously. Accordingly, there are produced magnetic actions on five points respectively at five places of the drive magnetic wheel 8 on the drive shaft 1 and of the follower magnetic wheel 9 of the follower shaft 2. Consequently, it is possible to enhance the level of synchronism loss limitation and achieve a higher transmission torque, compared to the power transmission based on the magnetic action on one point at one place by the conventional driving apparatus.

### EXAMPLE 3

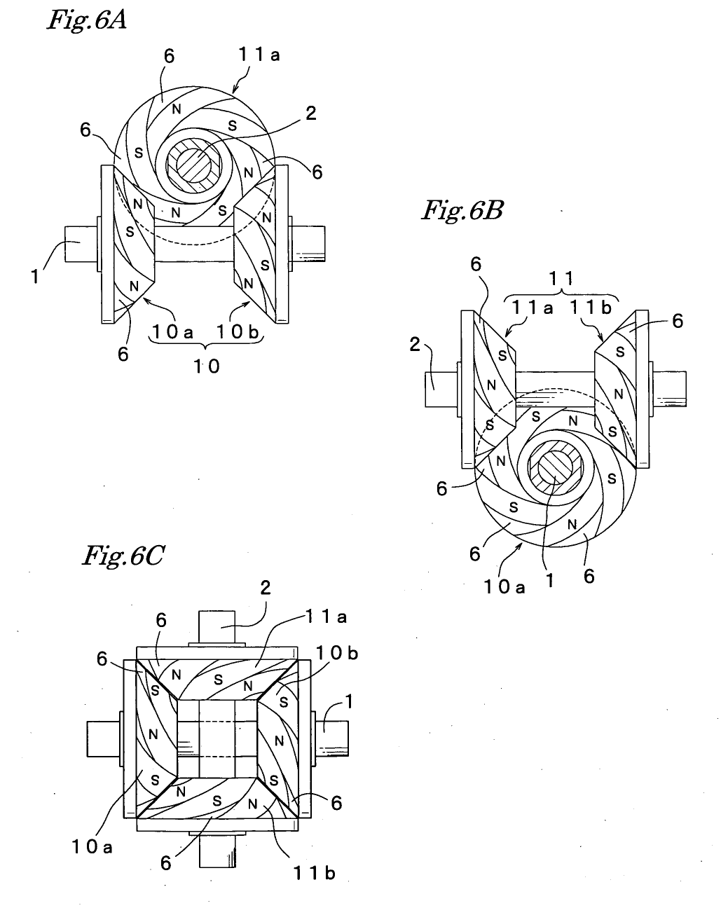

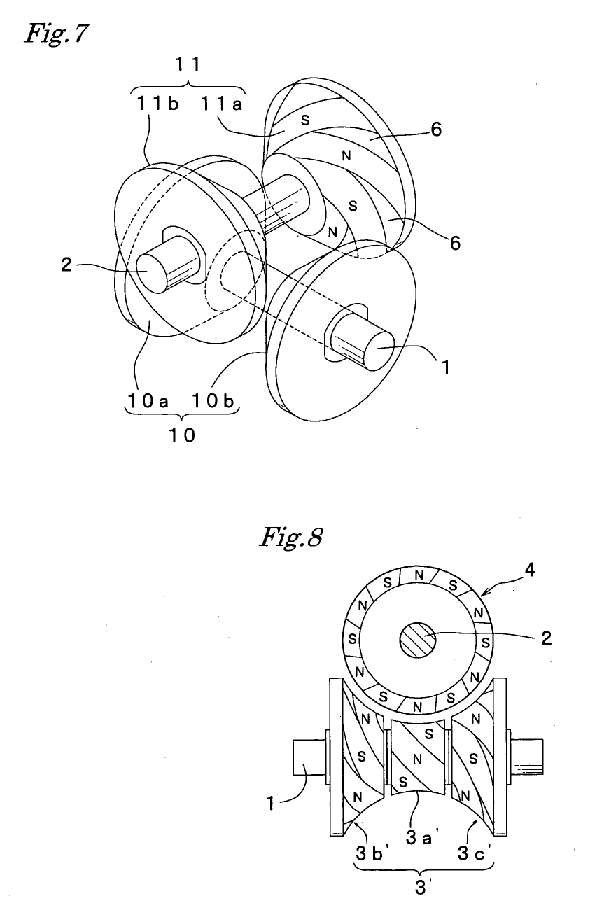

FIG. 6 and FIG. 7 show a driving apparatus having a drive magnetic wheel 10 fixed on the drive shaft 1 and a follower magnetic wheel 11 fixed on the follower shaft 2, both formed in an hourglass shaped, and those magnetic wheels 10 and 11 are arranged on the axes in such a manner that the truncated surfaces of the truncated conical shaped magnetic wheels are opposed to each other, and concave curves of the drive magnetic wheel 10 and the follower magnetic wheel 11 cross each other at right angles in a non-contact state.

In other words, the configuration in Example 3 corresponds to that of the drive magnetic wheel 8 and the follower magnetic wheel 9 shown in Example 2 from which the cylindrical shaped magnetic wheels 8a and 9a are removed. Here, the truncated conical shaped magnetic wheels 10a, 10b, and 11a, 11b respectively constituent elements of the drive magnetic wheel 10 and the follower magnetic wheel 11, are formed so that each has the same diameter.

In addition, the magnetization modes on the truncated conical shaped magnetic wheels 10a, 10b, and 11a, 11b respectively constitute the drive magnetic wheel 10 and the follower magnetic wheel 11 are established in the same manner as the magnetization modes on the truncated conical shaped magnetic wheels 8b, 8c, and 9b, 9c respectively constituting the drive magnetic wheel 8 and the follower magnetic wheel 9 as shown in Example 2.

In the driving apparatus configured as described above, the truncated conical shaped magnetic wheels 10a and 10b constituting the drive magnetic wheel 10 fixed on the drive shaft 1 produce magnetic actions respectively with the truncated conical shaped magnetic wheels 11a and 11b constituting the follower magnetic wheel 11. In other words, as for the truncated conical shaped magnetic wheels 10a and 10b of the drive magnetic wheel 10, two poles located nearly on the diameters respectively produce magnetic actions with the truncated conical shaped magnetic wheels 11a, 11b simultaneously. Accordingly, there are produced magnetic actions on four points respectively at four places of the drive magnetic wheel 10 on the drive shaft 1 and of the follower magnetic wheel 11 of the follower shaft 2. Consequently, it is possible to enhance the level of synchronism loss limitation and achieve a higher transmission torque, compared to the power transmission based on the magnetic action on one point at one place by the conventional driving apparatus.

FIG. 8 is a modification of the driving apparatus as described in Example 1, and outer surface of cylindrical magnetic wheel 3a′ and truncated conical shaped magnetic wheels 3b′ and 3c′ constituting drive magnetic wheel 3′ on the drive shaft 1 has a concave curve to face to the outer surface of the cylindrical shaped follower magnetic wheel 4 on the follower shaft 2, with a constant distance. With this configuration, the shape of the drive magnetic wheel can be more approximate the hourglass shape. Three magnetic wheels 3a′, 3b′ and 3c′ may be integrated into one piece. Similarly to the case as described above, the non-magnetized region 6 is formed between the magnetized zones of N-pole and S-pole, on the truncated conical shaped magnetic wheel.

Any of the hourglass shaped magnetic wheels as described in Example 1 to Example 3 shows an example which includes three constituent elements, a cylindrical shaped magnetic wheel, and truncated conical shaped magnetic wheels placed on both sides thereof, but the truncated conical shaped magnetic wheel may be placed on only one side, without placed on both sides.

Furthermore, the driving apparatus according to the present invention can be utilized for power transmission between two axes crossing each other at right angles, and it is applicable for power transmission from one drive shaft to one follower shaft or from one drive shaft to plural follower shafts (numerous follower shafts).

Since the driving apparatus according to the present invention brings about effects of a higher torque and high velocity rotation in addition to general effects of the driving apparatus utilizing magnetic force, it is beneficial to be used as a conveying machine such as a roller conveyer, which transports a heavy item or large sized substrate in a clean room. In other words, the drive magnetic wheels are arranged at even intervals on the drive shaft, and the follower shafts are located above the drive magnetic wheels being arranged to be orthogonal thereto, and rollers are respectively installed on the follower shafts to constitute a roller conveyer.

Having described specific preferred embodiments of the invention with reference to the accompanying drawings, it will be appreciated that the present invention is not limited to those precise embodiments, and that various changes and modifications can be effected therein by one of ordinary skill in the art without departing from the scope of the invention as defined by the appended claims.

What is claimed is:

1. A driving apparatus where a drive shaft and a follower shaft are arranged in such a manner as crossing each other at right angles, said drive shaft being driven to rotate appropriately by driving means, and a non-contact type power transmission mechanism utilizing magnetic force performs power transmission from said drive shaft to said follower shaft, wherein
magnetic wheels are installed respectively on said drive shaft and said follower shaft, each of the magnetic wheels being formed by spirally magnetized into N-pole and S-pole alternately and a plurality of points are coaxially provided which produce magnetic actions from one magnetic wheel to another magnetic wheel.

2. The driving apparatus according to claim 1, wherein
the magnetic wheel on said drive shaft is formed in an hourglass shape, and the magnetic wheel on said follower shaft is formed in a cylindrical shape that fits into a concave curve of said hourglass shaped magnetic wheel, and both of the magnetic wheels are arranged to be close to each other in a non-contact state.

3. The driving apparatus according to claim 2, wherein
the hourglass shaped magnetic wheel on said drive shaft comprises a cylindrical shaped magnetic wheel and truncated conical shaped magnetic wheels placed on both sides of said cylindrical shaped magnetic wheel, wherein truncated surfaces are arranged in such a manner as opposed to each other.

4. The driving apparatus according to claim 1, wherein
each of the magnetic wheels on said drive shaft and said follower shaft is formed in an hourglass shape, and the concave curves of both of the magnetic wheels cross each other at right angles in a non-contact state.

5. The driving apparatus according to claim 4, wherein
the hourglass shaped magnetic wheels on the driving shaft and on the follower shaft respectively comprise a cylindrical shaped magnetic wheel and truncated conical shaped magnetic wheels placed on both sides of the cylindrical shaped magnetic wheel, truncated surfaces of the truncated conical shaped magnetic wheels being arranged in such a manner as opposed to each other, and hourglass shaped magnetic wheels on both of the shafts cross each other at right angles in a non-contact state.

6. The driving apparatus according to claim 4, wherein
the hourglass shaped magnetic wheels on said driving shaft and on said follower shaft respectively comprise truncated conical shaped magnetic wheels, truncated surfaces thereof being arranged in such a manner as opposed to each other, and the hourglass shaped magnetic wheels on both of the shafts cross each other at right angles in a non-contact state.

7. The driving apparatus according to claim 3, wherein
the cylindrical shaped magnetic wheel as a constituent element of said hourglass shaped magnetic wheel is spirally magnetized into N-pole and S-pole alternately, and each of the truncated conical shaped magnetic wheels is spirally magnetized into N-pole and S-pole alternately as well as a non-magnetized region is formed between the N-pole and the S-pole.

8. The driving apparatus according to claim 5, wherein
the cylindrical shaped magnetic wheel as a constituent element of said hourglass shaped magnetic wheel is spirally magnetized into N-pole and S-pole alternately, and each of the truncated conical shaped magnetic wheels is spirally magnetized into N-pole and S-pole alternately as well as a non-magnetized region is formed between the N-pole and the S-pole.

9. The driving apparatus according to claim 6, wherein
the cylindrical shaped magnetic wheel as a constituent element of said hourglass shaped magnetic wheel is spirally magnetized into N-pole and S-pole alternately, and each of the truncated conical shaped magnetic wheels is spirally magnetized into N-pole and S-pole alternately as well as a non-magnetized region is formed between the N-pole and the S-pole.
